(19) United States
(12) Patent Application Publication
(10) Pub. No.: US 2016/0173654 A1
(43) Pub. Date: Jun. 16, 2016

(54) METHOD AND APPARATUS FOR LIVE-VIRTUAL-CONSTRUCTIVE INTEROPERATION

(71) Applicant: ELECTRONICS AND TELECOMMUNICATIONS RESEARCH INSTITUTE, Daejeon (KR)

(72) Inventor: Hyung-Kook JUN, Daejeon (KR)

(21) Appl. No.: 14/953,209

(22) Filed: Nov. 27, 2015

(30) Foreign Application Priority Data
Nov. 28, 2014 (KR) 10-2014-0168149
Nov. 25, 2015 (KR) 10-2015-0165159

(51) Int. Cl. H04L 29/06; H04L 29/12; H04L 12/66

(52) U.S. Cl. CPC H04L 69/22; H04L 69/18; H04L 12/66; H04L 61/255; H04L 69/08

(57) ABSTRACT

Disclosed herein are a method and apparatus for Live-Virtual-Constructive (L-V-C) interoperation. The L-V-C interoperation apparatus includes an L-V-C gateway for providing interoperation between protocols used in multiple systems, and an L-V-C router for extending a range of interoperation to a Wide Area Network (WAN) by configuring an L-V-C backbone. Multiple systems for interoperation include at least some of a live system, a virtual training system, and a constructive simulation system. The L-V-C gateway provides data conversion between heterogeneous types of middleware of multiple systems. The L-V-C router performs interoperation with another external L-V-C router.

### CROSS REFERENCE TO RELATED APPLICATIONS

This application claims the benefit of Korean Patent Application Nos. 10-2014-0168149, filed Nov. 28, 2014 and 10-2015-0165159, filed Nov. 25, 2015, which are hereby incorporated by reference in their entirety into this application.

### BACKGROUND OF THE INVENTION

1. Technical Field

The following embodiments generally relate to interoperation between systems and, more particularly, to a method and apparatus for Live-Virtual-Constructive (L-V-C) interoperation.

2. Description of the Related Art

Recently, national defense paradigms have changed to Network Centric Warfare (NCW). NCW means that all armies, weapon systems, and soldiers participating in a given battlefield are integrated and operated.

In NCW, an organic military operation between all entities participating in a battlefield is required. Further, interoperation between various types of simulation training systems that are separately operated is the essential factor of NCW.

In the past, a live system, a virtual training system, and a constructive simulation system were individually operated. In contrast, in NCW, operation execution training via organic combination between a live system, a virtual training system, and a constructive simulation system is required. Further, in NCW, interoperation technology in a large-scale Live-Virtual-Constructive (L-V-C) system is required.

In existing systems, partial interoperation that uses individual interoperability middleware has been performed. In contrast, in the L-V-C system, interoperation between heterogeneous types of middleware is required.

Interoperation in the L-V-C system provides a large number of combat and/or tactical training functions in an actual battlefield environment. Therefore, interoperation in the L-V-C system requires interoperability middleware technology in which various heterogeneous combat systems are capable of providing integrated operation. Even in a composite simulation system, the requirement of interoperation with other simulation systems has increased. However, due to the coexistence of heterogeneous servers, languages, and networking technologies, there is difficulty in interoperation with other simulation systems.

Further, domestic simulation training systems are chiefly constructed based on High Level Architecture (HLA) and/or Run Time Infrastructure (RTI). As interoperability middleware in real national defense systems, an Object Management Group (OMG) Data Distribution Service (DDS) has been used. Therefore, interoperability technology between pieces of middleware is required so as to construct the L-V-C system.

Also, HLA/RTI-based domestic distribution simulation is problematic in that it is limited in the transmission of real-time large-scale data and the provision of Quality of Service (Qos), and interoperability and scalability are insufficient in interoperation between separate pieces of middleware and heterogeneous types of middleware.

Currently, the development of technology for integrated interoperability middleware for L-V-C interoperation has not yet been conducted. Interoperability middleware that is technology required for interoperation between respective systems corresponding to a live system, a virtual training system, and a constructive simulation training system has been partially developed.

However, since the characteristics and usage environments of previously developed interoperability middleware differ from each other, it is difficult to implement interoperation between heterogeneous types of middleware. Further, such problems cause difficulty in reusing L, V, and C training systems that have already been developed. Such difficulties result in an increase in development costs and maintenance costs.

### SUMMARY OF THE INVENTION

An embodiment is intended to provide an apparatus and method for L-V-C interoperation, which support interoperation between a live system, a virtual training system, and a constructive simulation system.

Another embodiment is intended to provide an apparatus and method for generating code of an L-V-C gateway for protocol conversion between various heterogeneous types of middleware.

A further embodiment is intended to provide an L-V-C gateway for interoperation between heterogeneous types of middleware.

Yet another embodiment is intended to provide an L-V-C router for extending the local interoperation of the L-V-C gateway to a WAN environment.

In accordance with an embodiment, there is provided an apparatus for a Live-Virtual-Constructive (L-V-C) interoperation, including an L-V-C gateway for providing interoperation between protocols used in multiple systems; and an L-V-C router for extending a range of interoperation to a Wide Area Network (WAN) by configuring an L-V-C backbone.

The multiple systems may include a live system, a virtual training system, and a constructive simulation system.

Interoperation between the L-V-C gateway and the L-V-C router may be performed via a Data Distribution Service (DDS).

The L-V-C router may perform interoperation with an external additional L-V-C router by configuring an Internet Protocol (IP) routing table.

The L-V-C gateway may provide data conversion between heterogeneous types of middleware for the multiple systems.

The heterogeneous types of middleware may include at least one of High Level Architecture (HLA), a Data Distribution Service (DDS), Test and training ENabling Architecture (TENA), and a Distributed Interactive Simulation (DIS).

The L-V-C gateway may receive data from first middleware, perform mapping of communication objects for performing data conversion between heterogeneous types of middleware, and convert data received from a first middleware into data of second middleware based on the mapping of the communication objects.

The communication objects may be HLA objects or DDS entities.

The L-V-C gateway may perform mapping of data transmission/reception APIs for performing data conversion between heterogeneous types of middleware, and convert the received data into data of the second middleware based on the mapping of the data transmission/reception APIs.

In accordance with another embodiment, there is provided a Live-Virtual-Constructive (L-V-C) gateway, including a processing unit for processing interoperation between protocols used in multiple systems; and a communication unit for performing communication with the multiple systems.

The processing unit may process data conversion between heterogeneous types of middleware for the multiple systems.

The processing unit may perform mapping of communication objects for performing data conversion between the heterogeneous types of middleware, and convert received data into data of second middleware based on the mapping of the communication objects.

The processing unit may perform mapping of data transmission/reception Application Programming Interfaces (APIs) for performing data conversion between the heterogeneous types of middleware, and converts the received data into data of the second middleware based on the mapping of the data transmission/reception APIs.

In accordance with a further embodiment, there is provided a method for generating Live-Virtual-Constructive (L-V-C) gateway code, including generating Real-time Platform-level Reference Federation Object Model (RPR-FOM) information by parsing an RPR-FOM; generating, using the RPR-FOM information, a High Level Architecture (HLA) header and a Data Distribution Service (DDS) header that are used by HLA and DDS; generating a communication object required for communication between the HLA and the DDS using the HLA header and the DDS header; and generating source code required for data interoperation between the HLA and the DDS using the communication object.

Generating the RPR-FOM information may include parsing an RPR-FOM Extensible Markup Language (XML) document; and extracting data information of the communication object defined in the RPR-FOM, based on results of parsing the RPR-FOM XML document, wherein the RPR-FOM information comprises the data information.

The data information may include definition of a data type of the communication object and definition of an attribute of the communication object.

The HLA header may include information about an object class used in the HLA and the DDS header may include information about a topic structure used in the DDS.

The communication object may be configured to, in each of multiple pieces of middleware, perform data interoperation and data conversion between the multiple pieces of middleware.

The communication object may generate an HLA object using the HLA header and generate a DDS entity using the DDS header.

The communication object may provide a mapping relationship between the HLA object and the DDS entity and a mapping relationship between APIs for data conversion between multiple pieces of middleware.

In addition, other methods, apparatuses, and systems for implementing the present disclosure, and a computer-readable storage medium storing a computer program for executing the method are further provided.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an L-V-C interoperation apparatus according to an embodiment;

FIG. 2 is a diagram showing the interoperation structure of an L-V-C interoperation apparatus according to an embodiment;

FIG. 3 illustrates the operation of an L-V-C router according to an embodiment;

FIG. 4 is a configuration diagram showing an L-V-C router according to an embodiment;

FIG. 5 illustrates the function of an L-V-C router according to an embodiment;

FIG. 6 is a configuration diagram showing an apparatus for generating code of an L-V-C gateway according to an embodiment;

FIG. 7 illustrates the function of the L-V-C gateway code generation apparatus according to an embodiment;

FIG. 8 illustrates the operations of modules of the L-V-C gateway code generation apparatus according to an embodiment;

FIG. 9 is a flowchart showing a method for generating L-V-C gateway code according to an embodiment;

FIG. 10 illustrates the data conversion function of the L-V-C gateway according to an embodiment;

FIG. 11 illustrates the data conversion structure of the L-V-C gateway according to an embodiment; and

FIG. 12 is a flowchart showing a data conversion method according to an embodiment.

### DESCRIPTION OF THE PREFERRED EMBODIMENTS

Detailed description of the following exemplary embodiments will be made with reference to the attached drawings illustrating specific embodiments. These embodiments are described so that those having ordinary knowledge in the technical field to which the present disclosure pertains can easily practice the embodiments. It should be noted that various embodiments are different from each other, but do not need to be mutually exclusive to each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of exemplary embodiments is limited only by the accompanying claims, along with equivalents thereof, as long as they are appropriately described.

In the drawings, similar reference numerals are used to designate the same or similar functions in various aspects. The shapes, sizes. etc. of components in the drawings may be exaggerated to make the description clear.

It should be understood that a representation indicating that a first component is “connected” or “coupled” to a second component may include the case where the first component is connected or coupled to the second component with some other component interposed therebetween, as well as the case where the first component is “directly connected” or “directly coupled” to the second component. Further, in the exemplary embodiments, it should be understood that a representation “including a specific component” is merely intended to indicate that additional components can be included in the scope of the practice of the exemplary embodiments or the technical spirit thereof, and is not intended to exclude a possibility that one or more other components will be present or added.

The terms such as “first” and “second” may be used to describe various components, but those components should not be limited by the terms. The terms are merely used to distinguish one component from other components. For example, a first component may be designated as a second component and a second component may be designated as a first component in the similar manner, without departing from the scope of the embodiments.

Further, the components described in the embodiments are independently illustrated to exhibit different characteristic functions and are not intended to indicate that each component is implemented only as separate hardware or a single software component. That is, the components are listed as separate components for the convenience of description. For example, at least two of multiple components may be integrated into a single component. Further, a single component may be divided into multiple components. Embodiments in which individual components are integrated and embodiments in which each component is divided into multiple components are also included in the scope of the embodiments, without departing from the spirit of the embodiments.

Furthermore, some components may be selective components for merely improving performance rather than essential components for performing essential functions. Embodiments may be implemented to include only essential components required to implement essential substances of embodiments. For example, structures except for selective components, such as components used to merely improve performance, are also included in the scope of the embodiments.

Hereinafter, embodiments will be described in detail with reference to the accompanying drawings so that those having ordinary knowledge in the technical field to which the present invention pertains can easily practice the embodiments. In the following description of the embodiments, detailed descriptions of known functions and configurations that are deemed to make the gist of the present invention obscure will be omitted.

In the following embodiments, an apparatus and method for L-V-C interoperation, which enable a live system, a virtual training system, and a constructive simulation training system to be interoperable with each other, are proposed.

The L-V-C interoperation apparatus may include an L-V-C gateway and an L-V-C router. The L-V-C gateway may convert protocols that are used for L-V-C interoperation.

The L-V-C router may be used to overcome a limitation in which the interoperation of the L-V-C gateway is locally restricted. The L-V-C router may provide scalability so that L-V-C interoperability middleware can be operated in a Wide Area Network (WAN).

The L-V-C gateway may provide interoperation methods between various types of interoperability middleware that are used for interoperation with a live system, a virtual training system, and a constructive simulation system, respectively. The L-V-C gateway may perform protocol conversion between pieces of interoperability middleware as a principal function.

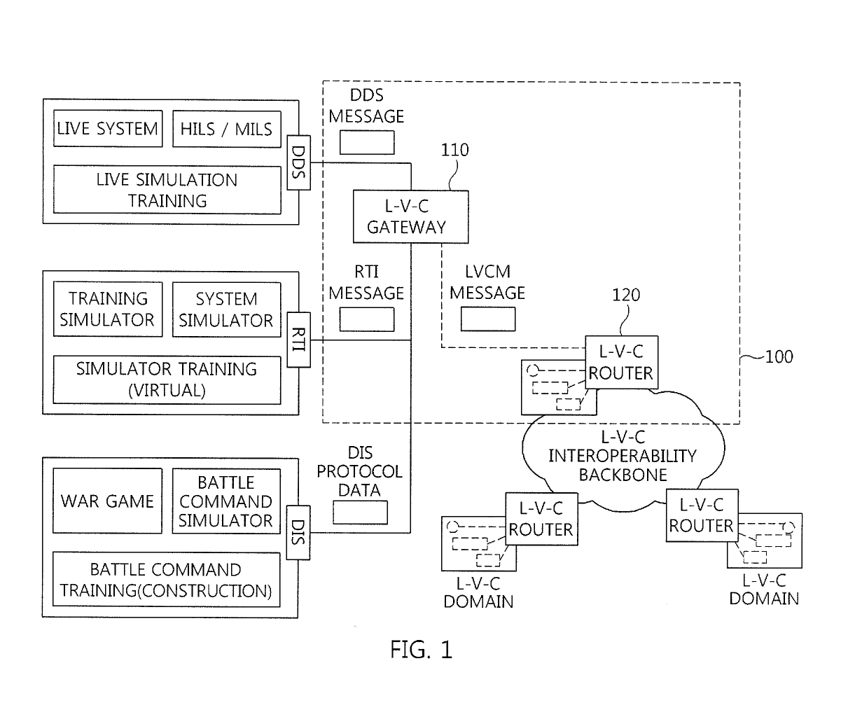

FIG. 1 illustrates the configuration of an apparatus for L-V-C interoperation according to an embodiment.

An L-V-C interoperation apparatus 100 may include an L-V-C gateway 110 and an L-V-C router 120. The L-V-C interoperation apparatus 100 may further include multiple systems. Alternatively, the multiple systems may be located outside of the L-V-C interoperation apparatus 100. The L-V-C interoperation apparatus 100 may communicate with the multiple systems or may interact with the multiple systems.

The L-V-C gateway 110 and the L-V-C router 120 of the L-V-C interoperation apparatus 100 may be independently operating devices. Therefore, the L-V-C interoperation apparatus 100 may be regarded as an L-V-C system.

The L-V-C gateway 110 may provide interoperation between protocols used in the multiple systems.

The multiple systems may include 1) a live system for live simulation training, 2) a virtual training system for simulator training, and 3) a constructive simulation system for battle command training.

As the live simulation training, 1) a live system and 2) Hardware In the Loop Simulation (HILS)/Model In the Loop Simulation (MILS) are illustrated. As the simulator training, 1) a training simulator and 2) a system simulator are illustrated. Further, as the battle command training, 1) a war game and 2) a battle command simulator are illustrated.

In addition, as middleware for live simulation training, a Data Distribution Service (DDS) is illustrated, and as middleware for simulator training, Run Time Infrastructure (RTI) is illustrated. Further, as middleware for battle command training, Distributed Interactive Simulation (DIS) is illustrated.

The L-V-C gateway 110 may communicate with heterogeneous types of middleware for multiple systems. Also, the L-V-C gateway 110 may provide data conversion between heterogeneous types of middleware for the multiple systems. The heterogeneous types of middleware may include at least one of High Level Architecture (HLA), Data Distribution Service (DDS), Test and training ENabling Architecture (TENA), and Distributed Interactive Simulation (DIS).

From the standpoint of the provision of data conversion between the heterogeneous types of middleware, the L-V-C gateway 110 may also be referred to as an “L-V-C middleware gateway”.

For example, for communication between the L-V-C gateway 110 and the DDS, a DDS message may be used. For communication between the L-V-C gateway 110 and the RTI, an RTI message may be used. For communication between the L-V-C gateway 110 and the DIS, DIS protocol data may be used.

The L-V-C router 120 forms an L-V-C backbone, and may then extend the range of interoperation between protocols used in multiple systems and that are provided by the L-V-C gateway 110 to the WAN.

Interoperation between the L-V-C gateway 110 and the L-V-C router 120 may be performed via a DDS. In FIG. 1, an LVCM message that is a message for communication between the L-V-C gateway 110 and the L-V-C router 120 may be used.

The L-V-C router 120 may communicate with external L-V-C routers belonging to other L-V-C domains via the L-V-C interoperability backbone.

Interoperation between the L-V-C router 120 and other L-V-C routers may be performed based on Transmission Control Protocol/Internet Protocol (TCP/IP). IP routing tables may be configured between the L-V-C router 120 and other L-V-C routers, and interoperation in the WAN may be performed via the IP routing tables. The L-V-C router 120 may interoperate with other external L-V-C routers by configuring the IP routing tables.

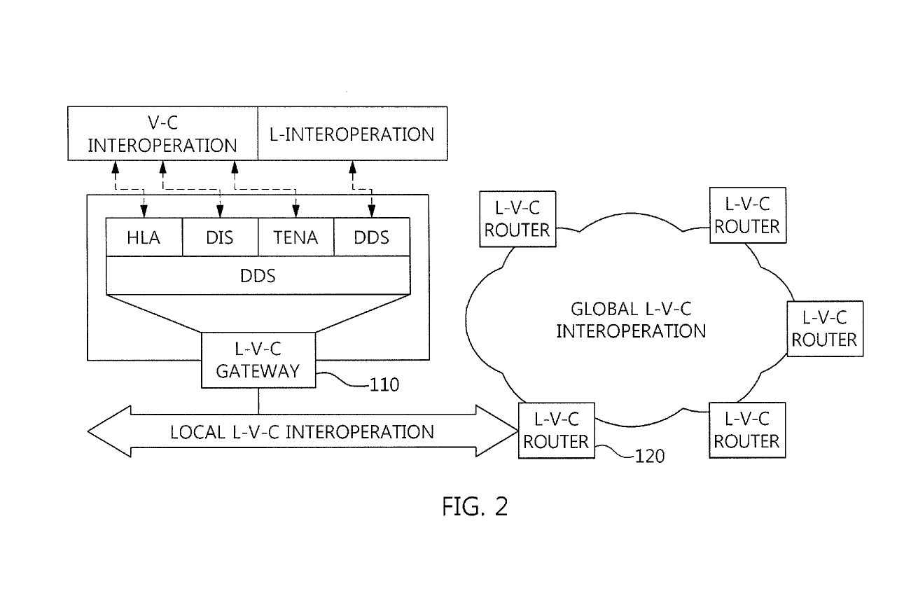

FIG. 2 illustrates the interoperation structure of the L-V-C interoperation apparatus according to an embodiment.

The L-V-C gateway 110 may function to interconnect heterogeneous types of middleware used for L-V-C interoperation, such as HLA, DIS, DDS, and TENA. The principal function of the L-V-C gateway 110 may be intended to connect data and services of heterogeneous types of middleware to each other.

The L-V-C gateway 110 may be operated in the form of a platform for converting data and/or services. Interoperation between HLA, DIS, DDS, and TENA may be performed using conversion via the upper layer of the L-V-C gateway 110.

The heterogeneous types of middleware used in the L-V-C interoperation may provide only interoperation in a local environment. For example, by means of V-C interoperation, interoperation between HLA, DIS, and TENA may be performed. Alternatively, DDS interoperation may be performed via L interoperation.

Therefore, for interoperation in a WAN environment, an additional device is required. The L-V-C router 120 may perform a function for interoperation in the WAN environment. The L-V-C gateway 110 may perform interoperation with the L-V-C router 120 via DDS that is a lower layer of the L-V-C gateway 110.

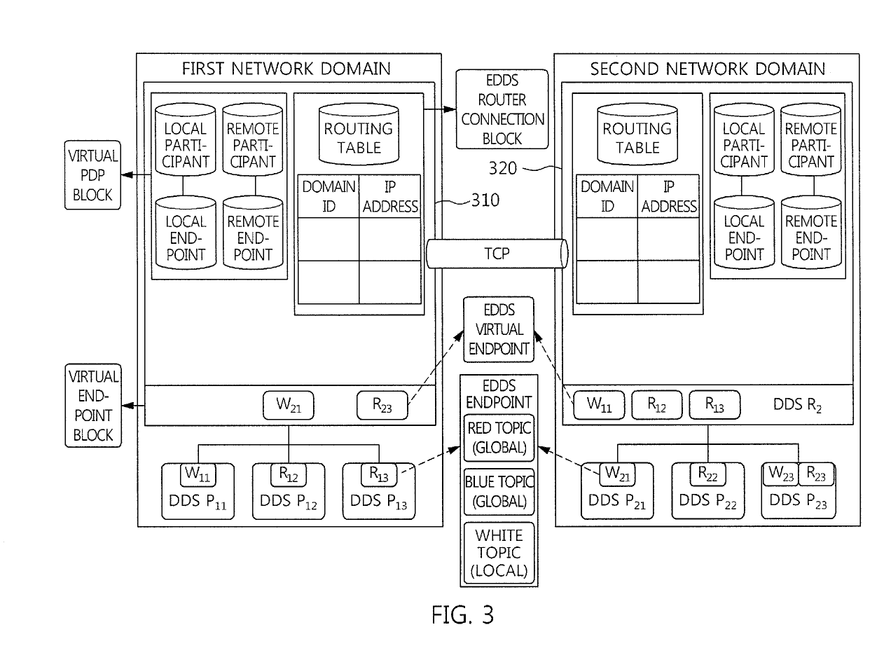

FIG. 3 illustrates the operation of the L-V-C router according to an embodiment.

As described above, the L-V-C router 120 may interoperate with other L-V-C routers 120 based on DDS.

FIG. 3 illustrates the interoperation and structures of L-V-C routers that are operating in two network domains. In FIG. 3, a first network domain and a second network domain are illustrated. Further, a first L-V-C router 310 operating in the first network domain and a second L-V-C router 320 operating in the second network domain are illustrated. For example, the first L-V-C router 310 may correspond to the L-V-C router 120, and the second L-V-C router 320 may correspond to another external L-V-C router 120.

First, when a DDS Pu is operated, the DDS P₁₁ may transmit the Participant Discovery Protocol (PDP) information of a PDP message to the first L-V-C router 310 of the first network domain. The first L-V-C router 310 may receive the PDP message from the DDS P₁₁.

Next, the first L-V-C router 310 may store the PDP message in a virtual PDP block. When the DDS P₁₁ generates a new data reader (DataReader) or a new data writer (DataWriter), the DDS P₁₁ may notify the first L-V-C router 310 of the first network domain that the DataReader and/or the DataWriter corresponding to a new communication node have been generated in the DDS P₁₁, by means of an Endpoint Discovery Protocol (EDP) message.

The first L-V-C router 310 may receive an EDP message from the DDS P₁₁. When the EDP message is received, the first L-V-C router 310 may store EDP information, indicating that the DataReader and/or DataWriter corresponding to the new communication node have been generated, in a virtual EDP block.

When the second L-V-C router 320 is newly generated in the second network domain, the routing table of the first network domain may store the IP information of the second L-V-C router 320 of the second network domain. When the IP information of the second L-V-C router 320 is generated in the routing table, the first L-V-C router 310 of the first network domain may recognize the generation of the second L-V-C router 320 of the second network domain.

When the generation of the second L-V-C router 320 is recognized, the first L-V-C router 310 may transmit both PDP information stored in the virtual PDP block and EDP information stored in the virtual EDP block to the second L-V-C router 320 of the second network domain over an IP network. The second L-V-C router 320 may receive the PDP information and the EDP information from the first L-V-C router 310.

When the PDP information and the EDP information are received, the second L-V-C router 320 of the second network domain may generate a virtual endpoint corresponding to the endpoint of the first network domain in the area of the DDS R₂ of the second network domain, based on the PDP information and the EDP information.

When the virtual endpoint is generated, and then the DataWriter w₁₁ of the DDS P₁₁ transmits data, the first L-V-C router 310 of the first network domain may receive data transmitted from the w₁₁. When the data is received, the first L-V-C router 310 may transmit the data to the second L-V-C router 320 of the second network domain through via a TCP. The second L-V-C router 320 may receive data from the first L-V-C router 310 through the TCP.

When the data is received, the second L-V-C router 320 may transmit the data to the second network domain through w₁₁ of a DDS R₂ corresponding to w₁₁ of the DDS P₁₁.

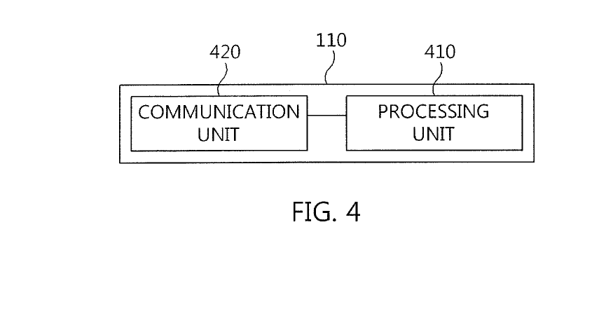

FIG. 4 is a configuration diagram showing the L-V-C gateway according to an embodiment.

The L-V-C gateway 110 may include a processing unit 410 and a communication unit 420.

The processing unit 410 may process tasks required for the operation of the L-V-C gateway 110. For example, the processing unit 410 may be at least one processor. The processing unit 410 may execute pieces of code corresponding to the operations or steps of the processing unit 410 described in the above embodiments.

The communication unit 420 may receive data or information required for the operation of the L-V-C gateway 110 and may transmit data or information required for the operation of the L-V-C gateway 110. The communication unit 420 may transmit data to other devices in a network and may receive data from the other devices. For example, the communication unit 420 may be a network chip or a port.

The operations, functions, and features of the processing unit 410 and the communication unit 420 of the L-V-C gateway 110 will be described in detail below with reference to embodiments.

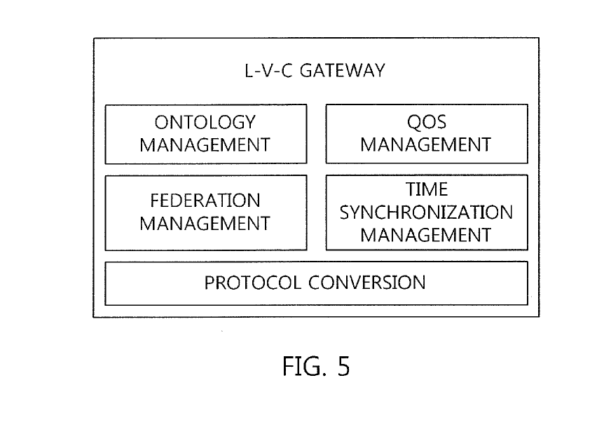

FIG. 5 illustrates the functions of the L-V-C gateway according to an embodiment.

The L-V-C gateway 110 may perform functions, such as ontology management, QoS management, federation management, time synchronization management, and protocol conversion. For example, the L-V-C gateway 110 may include an ontology management unit, a QoS management unit, a federation management unit, a time synchronization management unit, and a protocol conversion unit.

The ontology management unit may manage ontology required for the operation of the L-V-C gateway 110.

The QoS management unit may manage QoS required for the operation of the L-V-C gateway 110.

The federation management unit may manage federation required for the operation of the L-V-C gateway 110.

The time synchronization management unit may manage time synchronization required for the operation of the L-V-C gateway 110.

The protocol conversion unit may perform protocol conversion required for the operation of the L-V-C gateway 110.

In accordance with an embodiment, at least some of the ontology management unit, the QoS management unit, the federation management unit, the time synchronization management unit, and the protocol conversion unit may be program modules, and may communicate with external devices or systems. The program modules may be included in the L-V-C gateway 110 in the form of an Operating System (OS), an application program module, and other program modules.

The program modules may be physically stored in various well-known storage devices. Further, at least some of the program modules may also be stored in a remote storage device capable of communicating with the L-V-C gateway 110 through the communication unit 420.

The program modules may include, but are not limited to, routines, subroutines, programs, objects, components, data structures, etc. for performing functions or operations according to an embodiment or for implementing an abstract data type according to an embodiment.

The program modules may include instructions or code executed by the processing unit 410 of the L-V-C gateway 110. In an embodiment, the functions or operations that are described as being performed by the ontology management unit, the QoS management unit, the federation management unit, the time synchronization management unit, and the protocol conversion unit may also be regarded as being performed by the processing unit 410.

Method for Generating Code of L-V-C Gateway for L-V-C Interoperability Middleware

For conversion of protocols between various heterogeneous types of middleware, the L-V-C gateway 110 described in the embodiments may be used. The L-V-C gateway 110 provides L-V-C interoperability middleware. In the following description, a method for generating the code of the L-V-C gateway for L-V-C interoperability middleware will be described. The L-V-C gateway code required for L-V-C interoperation may be automatically generated based on various types of Federation Object Model (FOM) information without requiring a user's intervention. Further, based on the generation code, data conversion and protocol conversion functions required for L-V-C interoperation may be provided based on the generated code.

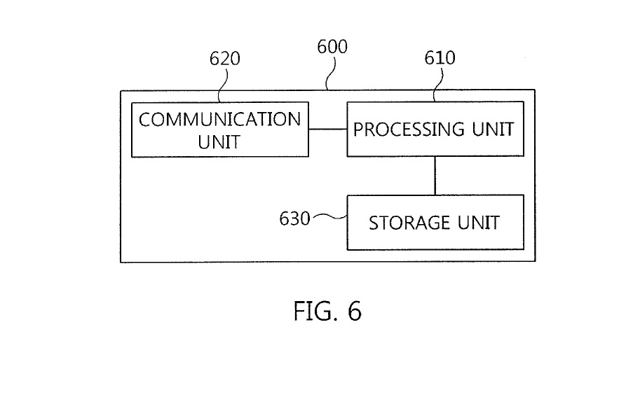

FIG. 6 is a configuration diagram showing an apparatus for generating L-V-C gateway code according to an embodiment.

An L-V-C gateway code generation apparatus 600 may include a processing unit 610, a communication unit 620, and a storage unit 630.

The processing unit 610 may process tasks required for the operation of the L-V-C gateway code generation apparatus 600. For example, the processing unit 610 may be at least one processor. The processing unit 610 may execute pieces of code corresponding to the operations or steps of the processing unit 610 described in the embodiments.

The communication unit 620 may receive data or information required for the operation of the L-V-C gateway code generation apparatus 600, and may transmit data or information required for the operation of the L-V-C gateway code generation apparatus 600. The communication unit 620 may transmit data to other devices in a network, and may receive data from the other devices. For example, the communication unit 620 may be a network chip or port.

The storage unit 630 may store data required for the operation of the L-V-C gateway code generation apparatus 600. For example, the storage unit 630 may be memory. The storage unit 630 may include an embedded storage medium, such as Random Access Memory (RAM) or flash memory, and may include a detachable storage medium, such as a memory card.

The operations, functions, and features of the processing unit 610, the communication unit 620, and the storage unit 630 of the L-V-C gateway code generation apparatus 600 will be described in detail below with reference to the following embodiments.

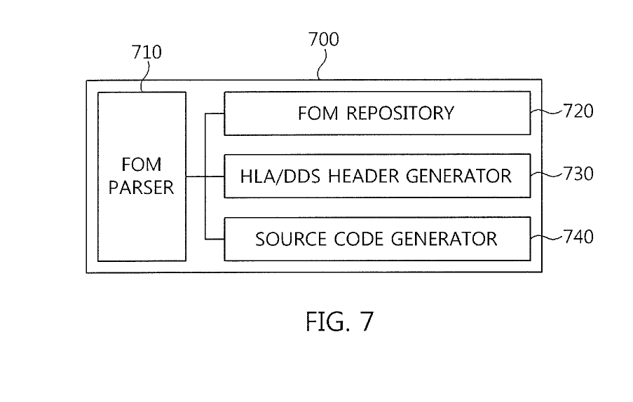

FIG. 7 illustrates the functions of the L-V-C gateway generation apparatus according to an embodiment.

The L-V-C gateway code generation apparatus 600 may perform functions such as Federation Object Model (FOM) parsing, FOM management, HLA/DDS header generation, and source code generation. In order to perform the above functions, the L-V-C gateway code generation apparatus 600 may include a FOM parser 710, a FOM repository 720, an HLA/DDS header generator 730, and a source code generator 740.

In according to an embodiment, some of the FOM parser 710, the FOM repository 720, the HLA/DDS header generator 730, and the source code generator 740 may be program modules and may communicate with external devices or systems. The program modules may be included in the L-V-C gateway code generation apparatus 600 in the form of an OS, an application program module, and other program modules.

The program modules may be physically stored in various types of well-known storage devices. Further, at least some of the program modules may be stored in a remote storage device capable of communicating with the L-V-C gateway code generation apparatus 600 through the communication unit 620.

The program modules may include, but are not limited to, routines, subroutines, programs, objects, components, data structures, etc. for performing functions or operations according to an embodiment or for implementing an abstract data type according to an embodiment.

The program modules may include instructions or code executed by the processing unit 610 of the L-V-C gateway code generation apparatus 600. In an embodiment, the functions or operations described as being performed by the FOM parser 710, the FOM repository 720, the HLA/DDS header generator 730, and the source code generator 740 may also be regarded as being performed by the processing unit 610.

The functions or operations of the FOM parser 710, the FOM repository 720, the HLA/DDS header generator 730, and the source code generator 740 will be described in detail below.

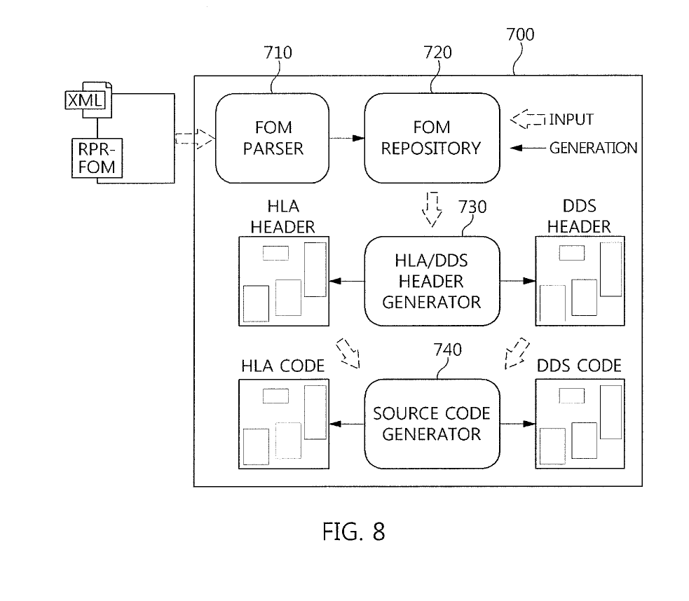

FIG. 8 illustrates the operations of the modules of the L-V-C gateway code generation apparatus according to an embodiment.

In FIG. 8, the input of data or information is indicated by bold dotted line arrows and the generation (or output) of data or information is indicated by solid line arrows.

A user who desires to generate the code of the L-V-C gateway 110 may create a Real-time Platform-level Reference Federation Object Model (RPR-FOM) Extensible Markup Language (XML) document. Such an RPR-FOM XML document may be provided as the input of the L-V-C gateway code generation apparatus 600.

The RPR-FOM may be an XML file in which the attributes and structure characteristics of objects that are used in HLA are described. The user may define a FOM to be used thereby in the form of an XML.

The RPR-FOM may provide a common data type between simulators. The RPR-FOM may be a standard for interoperation data that are used in HLA and RTI.

The FOM parser 710 may generate parsing information by parsing the RPR-FOM XML document. The FOM parser 710 may store the parsing information in the FOM repository 720. The parsing information may include data type information.

The FOM repository 720 may manage the parsing information as FOM management information.

The HLA/DDS header generator 730 may generate header information and data information that are used for the generation of HLA/DDS source code. The header information may include an HLA header and a DDS header. The term “DDS header” and the term “DDS topic” may be used as the same meaning and may be replaced with each other.

The HLA/DDS header generator 730 may generate the HLA header and the DDS header based on the data type information extracted by the FOM parser 710. The HLA/DDS header generator 730 may generate an object class used in the HLA, based on the data type information extracted by the FOM parser 710, and may generate a topic structure used in the DDS.

The HLA header may include information about the object class used in the HLA. Further, the DDS header may include information about the topic structure used in the DDS.

The HLA header and the DDS header may be generated in the form of a file. The HLA header and the DDS header may be required so as to provide data structure information required to generate actual HLA code and DDS code.

The source code generator 740 may generate source code that can be actually operated in the L-V-C gateway 110 using both the HLA header and the DDS header.

The source code generator 740 may generate communication objects required for communication between the HLA and the DDS using both the HLA header and the DDS header. The communication objects may be interoperable objects for L-V-C gateway interoperability.

The source code may be interoperable source code for L-V-C gateway interoperability. Further, the source code may include HLA executable source code and DDS executable source code.

The user may create an RPR-FOM to be used in the L-V-C gateway 110. The user may provide the RPR-FOM, created such that the HLA and DDS, which are interoperability middleware, may be operated in the L-V-C gateway 110, as the input file of the L-V-C gateway 110.

The source code generator 740 may generate source code for data interoperability between the HLA and the DDS using the generated communication objects.

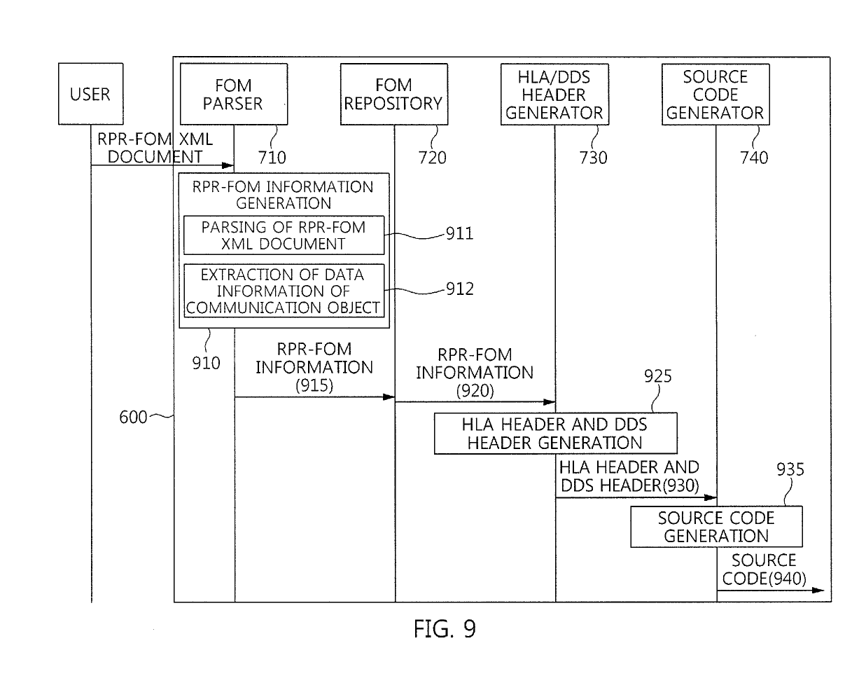

FIG. 9 is a flowchart showing a method for generating L-V-C gateway code according to an embodiment.

By the L-V-C gateway code generation method, data required for L-V-C middleware interoperability may be extracted.

First, the user may provide the RPR-FOM to the L-V-C gateway code generation apparatus 600. The RPR-FOM may be provided in the form of an RPR-FOM XML document.

At step 910, the FOM parser 710 may generate RPR-FOM information by parsing the RPR-FOM.

Step 910 may include steps 911 and 912.

At step 911, the FOM parser 710 may parse the RPR-FOM XML document. The FOM parser 710 may parse the RPR-FOM XML document in accordance with XML schema grammar.

At step 912, the FOM parser 710 may extract the data information of the communication objects defined in the RPR-FOM using the results of parsing the RPR-FOM XML document. For example, the FOM parser 710 may extract the data information of the communication objects defined in the RPR-FOM, based on XMI, structure information. The data information of the communication objects may include the definition of data types of the communication objects and the definition of the attributes of the communication objects. In other words, the FOM parser 710 may extract a data type for which the L-V-C gateway 110 intends to provide interoperation depending on the data type defined in the RPR-FOM.

The RPR-FOM information may include the data information of the communication objects.

By means of extraction and parsing at step 910, the definition of the data types and attributes of the communication objects may be acquired.

At step 915, the FOM parser 710 may transmit the RPR-FOM information to the FOM repository 720.

At step 920, the HLA/DDS header generator 730 may acquire the RPR-FOM information from the FOM repository 720.

At step 925, the HLA/DDS header generator 730 may generate a HLA header and a DDS header that are used in the HLA and the DDS using the RPR-FOM information.

At step 930, the source code generator 740 may acquire the HLA header and the DDS header from the HLA/DDS header generator 730.

At step 935, the source code generator 740 may generate source code required for data interoperation between the HLA and the DDS using the generated communication objects.

Further, at step 935, the source code generator 740 may generate the communication objects required for communication between the HLA and the DDS using the HLA header and the DDS header.

Here, the communication objects may be used for middleware interoperability. The communication objects may perform data communication in each of pieces of interoperability middleware. For example, the communication objects may be L-V-C interoperable HLA/DDS objects. The communication objects may perform actual data interoperation and actual data conversion in an L-V-C environment. Alternatively, in each of the multiple pieces of middleware, the communication objects may perform data interoperation and data conversion between the multiple pieces of middleware.

Each communication object may generate an HLA object using the HLA header or an HLA header file, and may generate a DDS entity using the topic header or a topic header file.

Further, the source code generator 740 may generate a mapping relationship between the generated HLA object and DDS entity. Furthermore, the source code generator 740 may provide a mapping relationship between Application Programming Interfaces (APIs) for data conversion between heterogeneous types of middleware. For example, the communication object may provide a mapping relationship between the HLA object and the DDS entity, and provide a mapping relationship between APIs for data conversion between multiple pieces of middleware.

The generated source code may be the executable code of the L-V-C gateway 110. The source code may generate operation code enabling the L-V-C gateway 110 to be operated based on information about the generated L-V-C interoperable HLA/DDS object.

At the above-described steps 910, 915, 920, 925, 930 and 935, the L-V-C gateway code generation apparatus 600 may generate the code of the L-V-C gateway 110 that performs the function of the L-V-C interoperability middleware. The generated code may be used in the L-V-C gateway 110.

At step 940, the source code generator 740 may output the generated source code.

Interoperation Method Between Heterogeneous Types of Middleware by L-V-C Gateway

In order for the L-V-C gateway 110 to provide interoperation between heterogeneous types of middleware, the data conversion and data interoperation between the heterogeneous types of middleware are required. Below, data conversion between the heterogeneous types of middleware will be described.

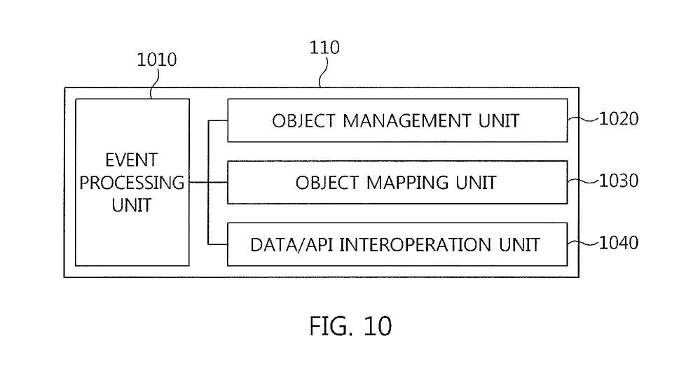

FIG. 10 illustrates the data conversion function of the L-V-C gateway according to an embodiment.

The L-V-C gateway 110 may perform functions, such as event processing, object management, object mapping, and data/API interoperation. To perform the above functions, the L-V-C gateway 110 may include an event processing unit 1010, an object management unit 1020, an object mapping unit 1030, and a data/API interoperation unit 1040. The functions may be performed as a part of data conversion by the L-V-C gateway 110. For example, the L-V-C gateway 110 may include a data conversion unit, which may include an event processing unit 1010, an object management unit 1020, an object mapping unit 1030, and a data/API interoperation unit 1040.

In accordance with an embodiment, at least some of the event processing unit 1010, the object management unit 1020, the object mapping unit 1030, and the data/API interoperation unit 1040 may be program modules, and are capable of communicating with external devices or systems. The program modules may be included in the L-V-C gateway 110 in the form of an OS, an application program module, and other program modules.

The program modules may be physically stored in various well-known storage devices. Further, at least some of the program modules may also be stored in a remote storage device capable of communicating with the L-V-C gateway 110 through the communication unit 420.

The program modules may include, but are not limited to, routines, subroutines, programs, objects, components, data structures, etc. for performing functions or operations according to an embodiment or for implementing an abstract data type according to an embodiment.

The program modules may include instructions or code executed by the processing unit 410 of the L-V-C gateway 110. In an embodiment, the functions or operations that are described as being performed by the event processing unit 1010, the object management unit 1020, the object mapping unit 1030 or the data/API interoperation unit 1040 may also be regarded as being performed by the processing unit 410.

The data conversion procedure performed by the L-V-C gateway 110 may include data conversion and data interoperation between heterogeneous types of middleware. The data conversion procedure may be configured to convert data and messages received from respective pieces of interoperability middleware of the HLA and the DDS into data and messages based on protocols of another HLA or DDS via a data conversion function, and transfer the converted data and messages to the other HLA or DDS.

The data conversion unit may implement functions required for data conversion and data interoperation based on the source code generated by the L-V-C gateway code generation apparatus 600. Further, the data conversion unit may perform data interoperation between data communication objects of HLA and/or DDS, based on the FOM information used by the L-V-C gateway code generation apparatus 600.

The principal functions of the data conversion procedure may include 1) processing of transmission and reception of data between the HLA and the DDS, 2) API conversion between heterogeneous types of middleware, 3) mapping of data communication objects to process communication between heterogeneous types of middleware, and 4) mapping of data communication APIs required to actually perform data conversion between heterogeneous types of middleware.

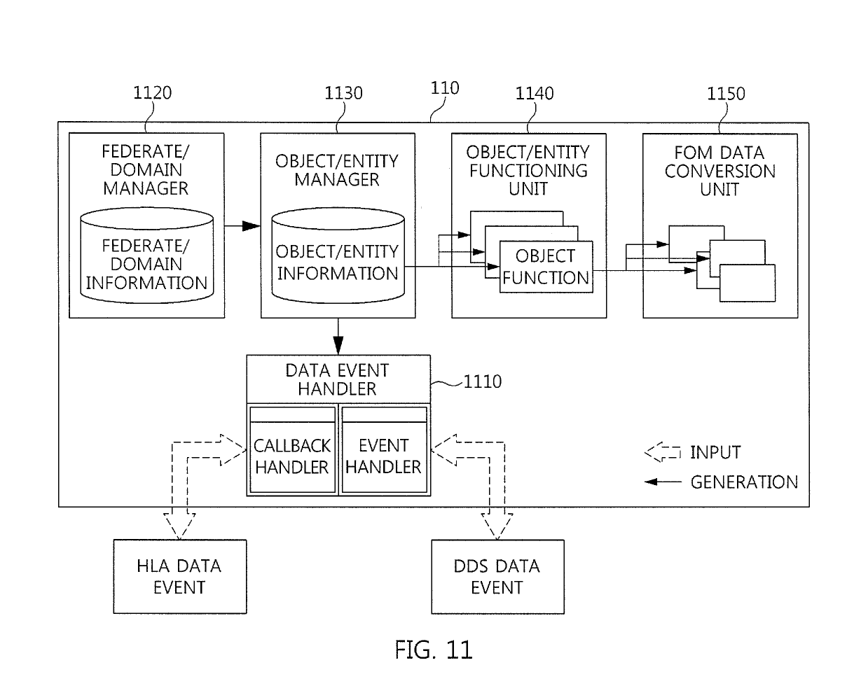

FIG. 11 illustrates the data conversion structure of the L-V-C gateway according to an embodiment.

The L-V-C gateway 110 may process data conversion between heterogeneous types of middleware. For data conversion, the L-V-C gateway 110 may include a data event handler 1110, a federate (simulation application)/domain manager 1120, an object/entity manager 1130, an object/entity functioning unit 1140, and a FOM data conversion unit 1150.

In accordance with an embodiment, at least some of the data event handler 1110, the federate/domain manager 1120, the object/entity manager 1130, the object/entity functioning unit 1140, and the FOM data conversion unit 1150 may be program modules and are capable of communicating with external devices or systems. The program modules may be included in the L-V-C gateway 110 in the form of an OS, an application program module, and other program modules.

The program modules may be physically stored in various well-known storage devices. Further, at least some of the program modules may also be stored in a remote storage device capable of communicating with the L-V-C gateway 110 through the communication unit 420.

The program modules may include, but are not limited to, routines, subroutines, programs, objects, components, data structures, etc. for performing functions or operations according to an embodiment or for implementing an abstract data type according to an embodiment.

The program modules may include instructions or code executed by the processing unit 410 of the L-V-C gateway 110. In an embodiment, the functions or operations that are described as being performed by the data event handler 1110, the federate/domain manager 1120, the object/entity manager 1130, the object/entity functioning unit 1140 or the FOM data conversion unit 1150 may also be regarded as being performed by the processing unit 410.

In FIG. 11, the input of data or information is indicated by bold dotted line arrows and the generation (or output) of data or information is indicated by solid line arrows.

The data event handler 1110 may process events from respective pieces of middleware for data conversion and data interoperation between heterogeneous types of middleware. Here, the processing of events may include recognizing reception of data from each middleware and providing notification of data reception.

The data event handler 1110 may sense an HLA data event and a DDS data event. When the HLA data event or the DDS data event is sensed, a callback handler or an event handler may be executed.

The federate/domain manager 1120 may configure a domain with which the middleware is interoperable using information about the federate (simulation application) and the domain with which the L-V-C gateway 110 may communicate, and may manage the domain. The federate and domain may be concepts respectively used in the HLA and the DDS. The middleware may be L-V-C interoperability middleware that is interoperable via the L-V-C gateway 110.

The object/entity manager 1130 may manage communication objects for data conversion and data interoperation between heterogeneous types of middleware. The communication objects may include HLA communication objects and DDS communication objects. Further, the object/entity manager 1130 may perform mapping of the communication objects and may provide information about the mapping.

The object/entity functioning unit 1140 may manage APIs that are used by the communication objects for data conversion and data interoperation between heterogeneous types of middleware. The communication objects may include HLA communication objects and DDS communication objects. The APIs may include an API for data conversion and an API for data interoperation. Also, the object/entity functioning unit 1140 may perform mapping of APIs that are used by communication objects and may provide information about the mapping.

The FOM data conversion unit 1150 may provide the function of managing data types and converted data types that are used by respective communication objects for the purpose of data conversion and data interoperation between heterogeneous types of middleware. Here, each data type may denote the type of data before conversion for another middleware, and each converted data type may denote the type of data after conversion for another middleware. The communication objects may include HLA communication objects and DDS communication objects.

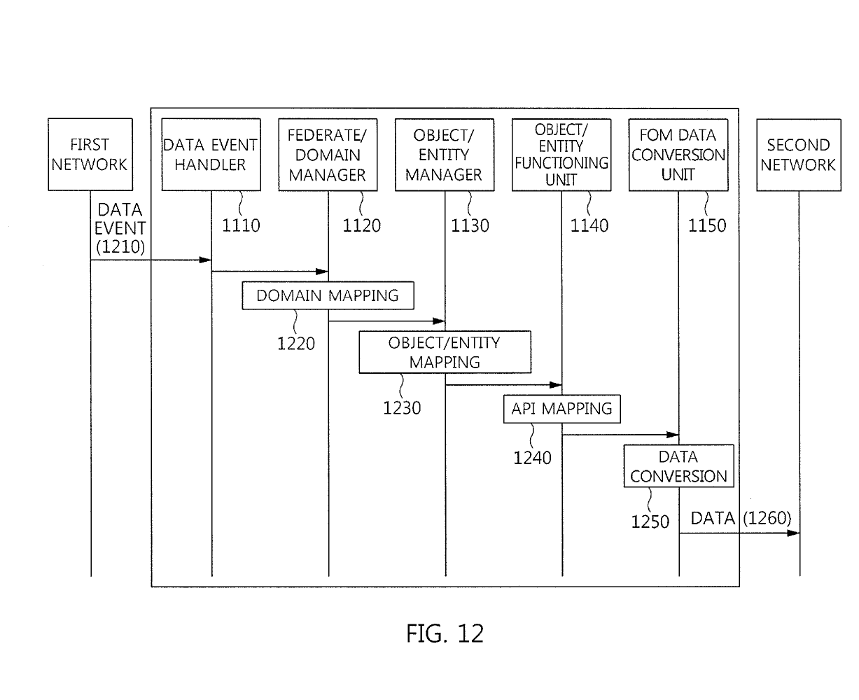

FIG. 12 is a flowchart showing a data conversion method according to an embodiment.

In FIG. 12, arrows in a direction from left to right may indicate the flow of execution or control, and vertical lines may indicate entities for performing respective operations.

In the following embodiment, the processing unit 410 may process interoperation between protocols used in multiple systems and may process data conversion between heterogeneous types of middleware for the multiple systems. Further, the communication unit 420 may perform communication between the multiple systems and between the heterogeneous types of middleware.

In the following embodiment, first middleware and second middleware may be heterogeneous types of middleware. In other words, in the following embodiment, a procedure for converting the data of the first middleware into the data of the second middleware may be described. The first middleware may be middleware for transmitting data and the second middleware for receiving data.

At step 1210, the communication unit 420 of the L-V-C gateway 110 may receive data from a first network. The first network may be a network corresponding to the first middleware. In other words, the first network may be a network for connecting the communication unit 420 of the L-V-C gateway 110 to the first middleware.

As the communication unit 420 receives the data, a data event may occur, and the data event handler 1110 may sense the occurrence of the data event. When the occurrence of the data event is sensed, the data event handler 1110 may receive the data from the first middleware.

At step 1220, the federation/domain manager 1120 may perform domain mapping.

The federation/domain manager 1120 may determine whether a data receiving object is a target to which the L-V-C gateway 110 provides interoperation. For example, the federation/domain manager 1120 may determine whether the data receiving object is an HLA federate and whether the data receiving object is a DDS domain participant. Here, the data receiving object may be an object related to data conversion and data interoperation between heterogeneous types of middleware. For example, the data receiving object may be at least one of communication objects of heterogeneous types of middleware that transmit data and communication objects of heterogeneous types of middleware that receive data. The communication objects may be HLA objects or DDS entities.

When the data receiving object is the object of middleware to which the L-V-C gateway 110 provides interoperation, step 1230 may be performed.

At step 1230, the object/entity manager 1130 may perform object/entity mapping.

The object/entity manager 1130 may search for objects and/or entities corresponding to the heterogeneous types of middleware, and may provide the mapping information of the objects and/or entities.

The object/entity manager 1130 may perform mapping for communication objects to perform data conversion between the heterogeneous types of middleware. The object/entity manager 1130 may provide information about objects and/or entities corresponding to the heterogeneous types of middleware and may provide the mapping information of the objects and/or entities.

At step 1240, the object/entity functioning unit 1140 may perform API mapping.

The object/entity functioning unit 1140 may search for APIs required for data conversion and data interoperation between objects and/or entities corresponding to the heterogeneous types of middleware and may provide the mapping information of the APIs.

The object/entity functioning unit 1140 may perform mapping for data transmission/reception APIs for performing data conversion between heterogeneous types of middleware. The object/entity functioning unit 1140 may provide information about the APIs corresponding to the objects and/or entities found at step 1230 and may provide the mapping information of the APIs.

At step 1250, the FOM data conversion unit 1150 may perform data conversion.

The FOM data conversion unit 1150 may provide data conversion information for actual data conversion. The data conversion information provided by the FOM data conversion unit 1150 may be used to convert data received from the first middleware into the data of the second middleware.

The FOM data conversion unit 1150 may convert the data received from the first middleware into the data of the second middleware based on the above-described mapping, that is, the mapping of the domains, the mapping of the communication objects, and the mapping of the data transmission/reception APIs.

At step 1260, the communication unit 420 may transmit the converted data to the second middleware over a second network. The second network may be a network corresponding to the second middleware. In other words, the second network may be a network for connecting the communication unit 420 of the L-V-C gateway 110 to the second middleware.

The embodiments of the present invention may be implemented in the form of program instructions that can be executed by various computer means and may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

Accordingly, an L-V-C interoperation apparatus and method for supporting interoperation between a live system, a virtual training system, and a constructive simulation system are provided.

There are provided an apparatus and method for generating the code of an L-V-C gateway for protocol conversion between various heterogeneous types of middleware.

There is provided an L-V-C gateway for interoperation between heterogeneous types of middleware.

There is provided an L-V-C router for extending the range of local interoperation of the L-V-C gateway to a WAN environment.

The L-V-C gateway provides convenience in interoperation between L-V-C systems, provides an environment in which interoperability between conventionally developed systems can be tested, and reduces costs required for L-V-C interoperability.

Although specific items such as detailed components in the present invention have been described with reference to limited embodiments and drawings, these are merely provided to help a clear understanding of the present invention, and are not intended to limit the present invention, and those skilled in the art can change and modify the present invention from the description of the invention.

Therefore, the spirit of the present invention should not be limited by the above-described embodiments and the accompanying claims, and all changes, equivalents or modifications thereof belong to the spirit and scope of the present invention.

What is claimed is:

1. An apparatus for a Live-Virtual-Constructive (L-V-C) interoperation, comprising:
an L-V-C gateway for providing interoperation between protocols used in multiple systems; and
an L-V-C router for extending a range of interoperation to a Wide Area Network (WAN) by configuring an L-V-C backbone.

2. The apparatus of claim 1, wherein the multiple systems comprise a live system, a virtual training system, and a constructive simulation system.

3. The apparatus of claim 1, wherein interoperation between the L-V-C gateway and the L-V-C router is performed via a Data Distribution Service (DDS).

4. The apparatus of claim 1, wherein the L-V-C router performs interoperation with an external additional L-V-C router by configuring an Internet Protocol (IP) routing table.

5. The apparatus of claim 1, wherein the L-V-C gateway provides data conversion between heterogeneous types of middleware for the multiple systems.

6. The apparatus of claim 5, wherein the heterogeneous types of middleware comprise at least one of High Level Architecture (HLA), a Data Distribution Service (DDS), Test and training ENabling Architecture (TENA), and a Distributed Interactive Simulation (DIS).

7. The apparatus of claim 1, wherein the L-V-C gateway receives data from first middleware, performs mapping of communication objects for performing data conversion between heterogeneous types of middleware, and converts the received data into data of second middleware based on the mapping of the communication objects.

8. The apparatus of claim 7, wherein the communication objects are HLA objects or DDS entities.

9. The apparatus of claim 7, wherein the L-V-C gateway performs mapping of data transmission/reception APIs for performing data conversion between heterogeneous types of middleware, and converts the received data into data of the second middleware based on the mapping of the data transmission/reception APIs.

10. A Live-Virtual-Constructive (L-V-C) gateway, comprising:
a processing unit for processing interoperation between protocols used in multiple systems; and
a communication unit for performing communication with the multiple systems.

11. The L-V-C gateway of claim 10, wherein the processing unit processes data conversion between heterogeneous types of middleware for the multiple systems.

12. The L-V-C gateway of claim 11, wherein the processing unit performs mapping of communication objects for performing data conversion between the heterogeneous types of middleware, and converts received data into data of second middleware based on the mapping of the communication objects.

13. The L-V-C gateway of claim 12, wherein the processing unit performs mapping of data transmission/reception Application Programming Interfaces (APIs) for performing data conversion between the heterogeneous types of middleware, and converts data received from a first middleware into data of the second middleware based on the mapping of the data transmission/reception APIs.

14. A method for generating Live-Virtual-Constructive (L-V-C) gateway code, comprising:
generating Real-time Platform-level Reference Federation Object Model (RPR-FOM) information by parsing an RPR-FOM;
generating, using the RPR-FOM information, a High Level Architecture (HLA) header and a Data Distribution Service (DDS) header that are used by HLA and DDS;
generating a communication object required for communication between the HLA and the DDS using the HLA header and the DDS header; and
generating source code required for data interoperation between the HLA and the DDS using the communication object.

15. The method of claim 14, wherein generating the RPR-FOM information comprises:
parsing an RPR-FOM Extensible Markup Language (XML) document; and
extracting data information of the communication object defined in the RPR-FOM, based on results of parsing the RPR-FOM XML document,
wherein the RPR-FOM information comprises the data information.

16. The method of claim 15, wherein the data information comprises definition of a data type of the communication object and definition of an attribute of the communication object.

17. The method of claim 14, wherein the HLA header comprises information about an object class used in the HLA and the DDS header comprises information about a topic structure used in the DDS.

18. The method of claim 14, wherein the communication object is configured to, in each of multiple pieces of middleware, perform data interoperation and data conversion between the multiple pieces of middleware.

19. The method of claim 14, wherein the communication object generates an HLA object using the HLA header and generates a DDS entity using the DDS header.

20. The method of claim 19, wherein the communication object provides a mapping relationship between the HLA object and the DDS entity and a mapping relationship between APIs for data conversion between multiple pieces of middleware.
